(19) United States
(12) Patent Application Publication
(10) Pub. No.: US 2026/0050692 A1
(43) Pub. Date: Feb. 19, 2026

(54) ANALYZING AND IDENTIFYING AUDIO AND VIDEO CALLS GENERATED BY ARTIFICIAL INTELLIGENCE

(71) Applicant: International Business Machines Corporation, Armonk, NY (US)

(72) Inventors: Paritosh RANJAN, Kolkata (IN); Bhubaneswar PADHAN, KOLKATA (IN); Prodip ROY, Kolkata (IN)

(21) Appl. No.: 18/802,212

(22) Filed: Aug. 13, 2024

(51) Int. Cl. G06F 21/64

(52) U.S. Cl. CPC G06F 21/64

(57) ABSTRACT

An approach for validating the authenticity of digital content between digital devices may be provided. The approach registers a first user with a server and registering and storing an approved contact associated with the first user. The approach creates unique IDs (identification) for the first user and a second user from the approved contact and generating a security code for a first user pair, wherein the first user pair contains the first user and the second user. The approach creates an A/V watermark for the first user pair and verifies the security code of the first user pair. The approach validates authenticity of the A/V watermark during a communication session and displaying authentication status during the communication session.

### TECHNICAL FIELD

The present invention relates generally to communication, and specifically, to authenticating communication session between users.

### BACKGROUND

Generative AI (artificial intelligence) is a type of AI technology that generates various contents (e.g., text, video, audio, etc.). Generative AI can leverage GANs (generative adversarial network) to produce convincingly real images, videos, and audio of real people. There have been several uses of generative AI in society, such as, the entertainment industry.

### BRIEF SUMMARY

According to an embodiment of the present invention, a computer-implemented method for validating the authenticity of digital content between digital devices, the computer-implemented method comprising: registering a first user with a server; registering and storing an approved contact associated with the first user; creating unique IDs (identification) for the first user and a second user from the approved contact; generating a security code for a first user pair, wherein the first user pair contains the first user and the second user; creating a first A/V watermark for the first user pair; validation of the first A/V watermark against a second A/V watermark during a communication session, wherein the second A/V watermark was created by the communication session; and displaying an authentication status during the communication session.

According to another embodiment of the present invention, there is provided a computer system. The computer system comprises a processing unit; and a memory coupled to the processing unit and storing instructions thereon. The instructions, when executed by the processing unit, perform acts of the method according to the embodiment of the present invention.

According to a yet further embodiment of the present invention, there is provided a computer program product being tangibly stored on a non-transient machine-readable medium and comprising machine-executable instructions. The instructions, when executed on a device, cause the device to perform acts of the method according to the embodiment of the present invention.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 depicts a computing environment 100, according to embodiments of the present invention;

FIG. 2 is a high-level system architecture, depicting interactions between devices and users, according to embodiments of the present invention;

FIG. 3 is a detailed architecture of FIG. 2, according to embodiments of the present invention; and

FIG. 4 is a flowchart of a method, according to embodiments of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several embodiments of detecting and identify authenticity of audio and video content from a user.

Embodiments of the present invention can provide the capability of a user to validate the authenticity of audio and/or video contents, transmitted from another user. Thus, the user can avoid possible scammers and malicious intent of unauthorized users trying to communicate with the user (receiving and/or target of the communication).

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

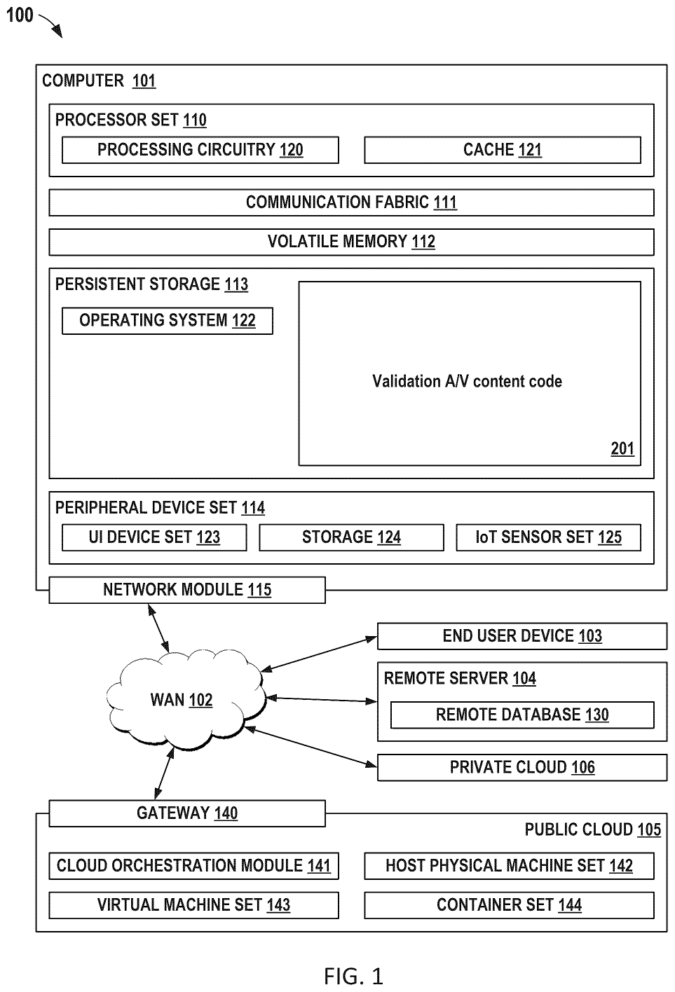

FIG. 1 includes computing environment 100, which will be explained in further details below.

Computing environment 100 contains an example of an environment for the execution of at least some of the computer code involved in performing the inventive methods, such as validation A/V (audio and video) content code 201. In addition to block 201, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 201, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 201 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 201 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

Validation A/V (audio and video) content code 201 can manage an authentication process between users during a communication session. Validation A/V content code 201 works in conjunction with a similar software residing on a server (i.e., server 120). For example, there is a client-side version and a server-side version of 201 that allows both devices to work together seamlessly.

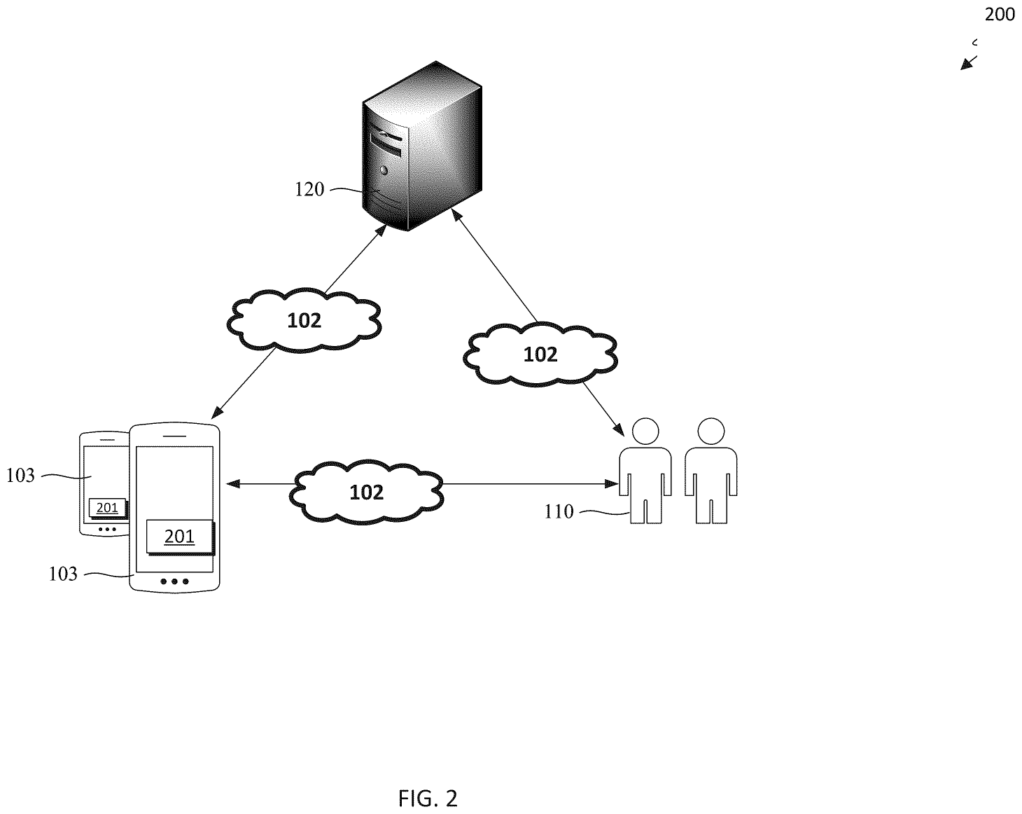

Additionally, prior to initially performing any actions, validation A/V content code 201 may perform an opt-in procedure. The opt-in procedure may include a notification of the data the validation A/V content code 201 may capture and the purpose for which that data may be utilized by the validation A/V content code 201 during data gathering and operation. Furthermore, notwithstanding depiction in computer 101, the screen sharing latency detection program 150 may be stored in and/or executed by, individually or in any combination, end user device 103, remote server 104, public cloud 105, and private cloud 106. The screen sharing latency detection method is explained in more detail below with respect to FIGS. 2-4.

It should be noted that the embodiments of the present invention may operate with a user's permission. Any data may be gathered, stored, analyzed, etc., with a user's consent. In various configurations, at least some of the embodiments of the present invention are implemented into an opt-in application, plug-in, etc., as would be understood by one having ordinary skill in the art upon reading the present disclosure.

FIG. 2 is a high-level system architecture, designated as system 200, depicting interactions between devices and users, according to embodiments of the present invention. System 200 comprises of, WAN 102, client device 103, server computer 120, users 110 and validation A/V content code 201.

Client device 103 can be any computing device on which software is installed for which an update is desired or required. Client device 103 can be a standalone computing device, management server, tablet, a web server, a mobile computing device, or any other electronic device or computing system capable of receiving, sending, and processing data. In other embodiments, client device 103 can represent a server computing system utilizing multiple computers as a server system. In another embodiment, client device 103 can be a laptop computer, a tablet computer, a netbook computer, a personal computer, a desktop computer or any programmable electronic device capable of communicating with other computing devices (not shown) within system 200 via WAN 102. Client device contains the validation A/V content code 201.

Server computer 120 can be a standalone computing device, management server, a web server, a mobile computing device, or any other electronic device or computing system capable of receiving, sending, and processing data. In other embodiments, server computer 120 can represent a server computing system utilizing multiple computers as a server system. In another embodiment, server computer 120 can be a laptop computer, a tablet computer, a netbook computer, a personal computer, a desktop computer, or any programmable electronic device capable of communicating with other computing devices (not shown) within system 200 via WAN 102.

WAN 102 can be, for example, a wide area network (WAN) such as the Internet, or a combination of the two, and can include wired, wireless, or fiber optic connections. In general, WAN 102 can be any combination of connections and protocols that will support communications between client device 103 and server computer 120.

In one aspect of an embodiment of the present invention, one or more users 110 are individuals that utilize client device 103 in order to communicate to another user of client device 103. For example, person A owns a smart mobile phone and a tablet. The mother of person A, designated as person B, owns a smart mobile phone. Person B calls person A, using a smart mobile phone every day. Both person A and B would be classified as one or more users 110.

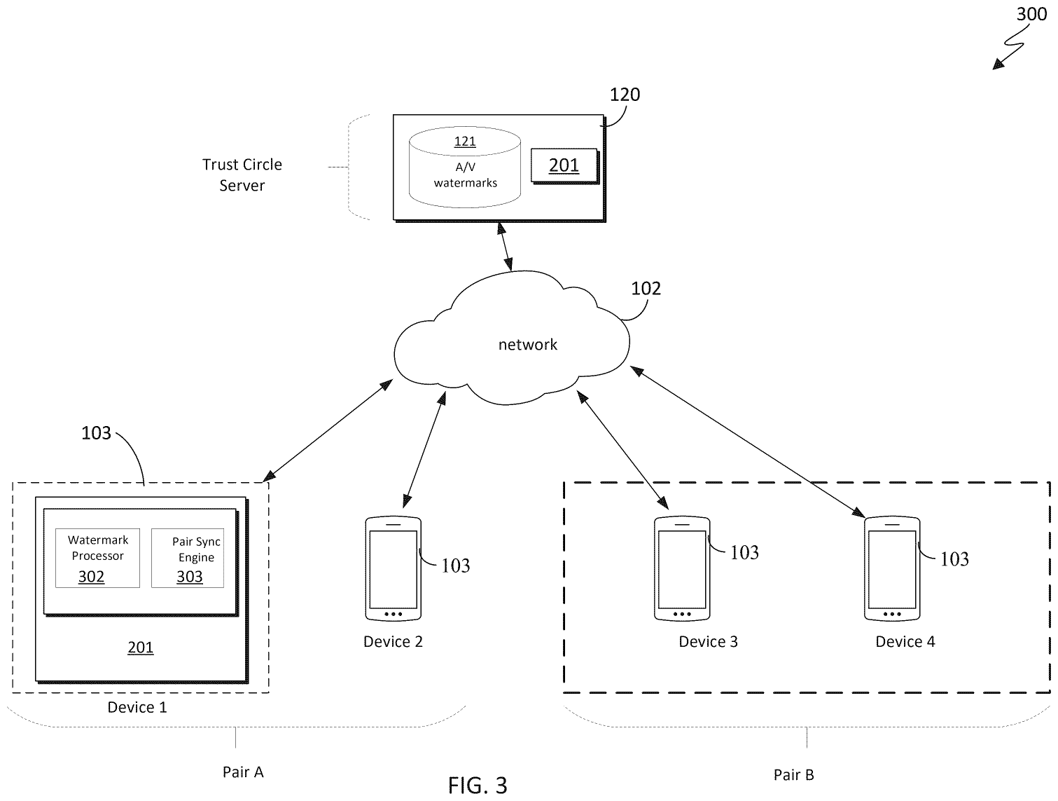

FIG. 3 is a detailed architecture of FIG. 2, designated as block 300, according to embodiments of the present invention. Block 300 contains similar components as from FIG. 2 but with the following additions, such as, watermark processor 302, pair sync engine 303 and A/V watermarks 121.

In one aspect of an embodiment of the present invention, watermark processor 302 is capable of creating a unique electronic identifier to an audio, still images or even video content. Any current digital watermarking technology may be utilized to embed information as an additional signal to a digital content that be later verified for authenticity. For example, watermarking an audio file may use SSW (spread spectrum watermarking) technique to embed a narrow-band signal.

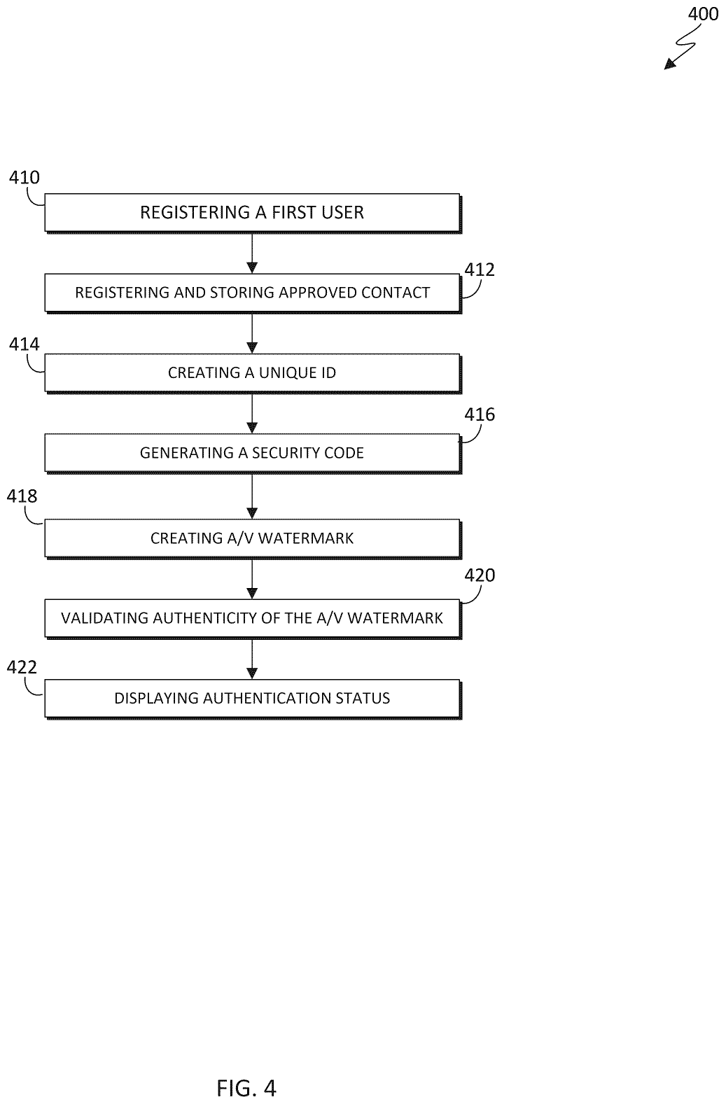

In one aspect of an embodiment of the present invention, pair sync engine 303 is capable of providing a handshaking protocol between client device 103 and server 120 after authentication has been granted. The protocol allows server 120 to share a security code with client device 103. Details of the steps/methods on the sharing of security code will be discussed in further detail with respect to FIG. 4.

Server 120 comprises of A/V watermarks 121 and validation A/V content code 201. In one aspect, a software (i.e., server-side version of 201) residing on server 120 works in conjunction with 201 (client-side version residing on the client device 103).

In another aspect of an embodiment of the present invention, A/V watermarks 121 can be a database for storing, at least, but not limited to, information related to users and contact list, a list of unique security codes (e.g., pairs that includes matching halves, etc.), a list of unique IDs (identification) and A/V watermarks. It is noted that server 120 can also be known as, Trust Circle server throughout the disclosure.

FIG. 4 is an exemplary flowchart of a method, designated as 400, for a user to validate the authenticity of audio and/or video contents, transmitted from another user. A use case scenario will be presented to illustrate the steps. The steps may refer to elements from FIGS. 1-4. There are at least 3 users (i.e., one or more users 110) in the scenario, user A, user B and user C. Each of the users utilizes a smart mobile device (i.e., client device 103) for communication. User B is the mother of user A. User C is a scammer. User A and user B, installs and setups a validation application, designated as Trust Circle application, on their respective smart mobile devices. The Trust Circle application communicate with a Trust Circle server over a network/internet.

At step 410, an embodiment can register a first user. For example, user A and user B both install Trust Circle application on their smart mobile device. Both users register and create an account with the Trust Circle application. At step 412, the embodiment can register and store approved contact list for user A and user B. For example, user A can add user B as an “approved/authorized” contact. Similarly, user B can also add user A to the approved list for user B. At step 414, the embodiment can create a unique ID for each user. For example, Trust Circle application can create a unique ID for user A and user B. The unique IDs can be stored on the server and/or on the smart devices.

At step 416, the embodiment can generate a security code for the users. For example, Trust Circle creates a security code containing two halves, one half is distributed to user A and one half is distributed to user B. User A and user B would be considered “paired” (i.e., “Pair A”). Referring to FIG. 3, device 1 (of user A) is paired with device 2 of user B. Similarly, other users, such as user D and user E can pair their devices (e.g., device 3 and device 4) together, creating a designated “Pair B” (i.e., a second security code for Pair B).

Furthermore, the embodiment can allow both users to “share” the security code. In the same aspect of an embodiment, the security code can be “shared” between the users without an involvement from Trust Circle server. For example, the security code can be shared by the following, but not limited to, methods: i) speak verbally on the client device or speaking verbally in person, ii) show the screen (of client device) to the other user, iii) sent via email and iv) sent via text message. Other complex methods of sharing can be used, such as, i) embedded QR (quick response) code and ii) share as a picture from which text can be extracted using an OCR (optical character recognition) technology.

Additionally, through pair sync engine 303, the embodiment can verify the combined security code. Users from the paired user, (i.e., user A and user B) will submit each of the half of the original security code back to the Trust Circle server. Trust Circle server will verify the combined security code from both users.

At step 418, through watermark processor 302, the embodiment can create A/V watermark for each user pair if the Trust Circle server acknowledges that the combined security code is authentic. The A/V watermark will be a “common” watermark for the user pair and are accessible by the client device belonging to the user pair. The common watermark can be stored on the server and on the client devices. There are two steps involved with A/V watermarking, the first step involves creating a watermark and second step involves overlaying the watermark onto a content. For example, device of user A can automatically create a watermark (or can be initiated by the user). The type of watermark created can include, but not limited to, audio and video watermarking. This common watermark will be “shared” (i.e., used) between a user pair (e.g., user A and user B constitutes Pair A). Shared watermark is terminology to denote that the watermark is accessible between the user pair. The common watermark can be stored on the server and/or on the client device. However, the “golden” record copy (i.e., latest version) would be stored on the server. It is noted if there are older versions of the watermarks, those older versions will be deleted.

At step 420, through watermark processor 302, the embodiment can validate the watermarked content during a communication session. A communication session can include, but is not limited to, a text message, a voice call, and a video call. A communication session is triggered automatically when a user that is part of the trusted pair (i.e., Pair A) initiates a communication session with a user from the same trusted pair. Once a communication session event is detected, the embodiment (on the client device of the user initiating a communication session) can overlay an A/V watermark during the communication session. The client device of the receiving communication sessions, via watermark processor 302, can extract the incoming A/V watermark during the communication session. Furthermore, the client device can validate the A/V watermark by comparing the incoming A/V watermark against the trusted and golden copy that is stored on the Trust Circle server.

At step 422, the embodiment can display the authentication status. Based on the comparison from the prior step, the embodiment can display the authenticity status of the communication session. For example, referring to the original use case scenario, user B calls user A. The client device of user A can display an authenticity status as, “Approved.” It is noted that other wording to display that a communication session is legitimate, can include, but it is not limited to, “Not Fake,” “Real” and “True.” Other wording to display that the communication session is not authentic can be, but it is not limited to, “Fake,” “Scam” and “Not Legit.” In an example, referring to the original use case scenario, user C (a scammer) calls user A, from their own device, but there is no watermark detected from user C then embodiment (by the Trust Circle app on the client device of user A) can determine that the call is fake.

However, in another example, referring to the original use case scenario, user B calls user A, but the watermark does not match the golden copy. In that example, the scenario may involve a situation when the user B and user A are legitimate user pair (e.g., have unique IDs and each half of the security code) but during the communication session, the watermark does not pass authentication. In that scenario, after the comparison step of the watermark against the golden copy, wherein the watermark has failed the authentication process, the embodiment can designate the communication session as “fake.” Thus, the authentication process can have at least three validation checks (e.g., 1) user added with unique IDs, 2) user pair is given a security code and 3) passing watermark comparison) before proceeding to determine if the communication session is legitimate or fake.

1. A computer-implemented method for validating the authenticity of digital content between digital devices, the computer-implemented method comprising:
registering a first user with a server;
registering and storing an approved contact associated with the first user;
creating unique IDs (identification) for the first user and a second user from the approved contact;
generating a security code for a first user pair, wherein the first user pair contains the first user and the second user;
creating a first A/V watermark for the first user pair;
validation of the first A/V watermark against a second A/V watermark during a communication session, wherein the second A/V watermark was created by the communication session; and
displaying an authentication status during the communication session.

2. The computer-implemented method of claim 1, wherein creating unique IDs for the first user and the second user from the approved contact further comprises:
creating a first unique ID for the first user;
creating a second unique ID for the second user; and
storing the first and second unique ID.

3. The computer-implemented method of claim 1, wherein generating the security code further comprises:
generating the security code, wherein the security code contains a first half of the security code and a second half of the security code;
assigning the first half to the first user and assigning the second half to the second user; and
transmitting the assigned first half to the first user and the assigned second half to the second user.

4. The computer-implemented method of claim 1, wherein creating the A/V watermark further comprises:
verifying the security code of the first user pair; and
creating an A/V watermark for the first and the second user.

5. The computer-implemented method of claim 1, wherein verifying the security code further comprises:
retrieving the first half of the security code from the first user;
retrieving the second half of the security code from the second user;
combining the first half and the second half to create a combined security code;
comparing the combined security code against the security code; and
determining whether the combined security code matches the security code based on the comparison.

6. The computer-implemented method of claim 1, wherein validation of the A/V watermark further comprises:
detecting a presence of the second A/V watermark that is transmitted by the second user to the first user during a communication session;
retrieving the first A/V watermark from the server;
comparing the second A/V watermark against the first A/V watermark; and
generating the authentication status based on the comparison.

7. The computer-implemented method of claim 1, wherein the communication session is selected from a group consisting of a text message, a voice call, and a video call.

8. A computer program product for validating the authenticity of digital content between digital devices, the computer program product comprising:
one or more non-transitory computer-readable storage media having computer-readable program instructions stored on the one or more computer-readable storage media said program instructions executes a computer-implemented method comprising the steps of:
registering a first user with a server;
registering and storing an approved contact associated with the first user;
creating unique IDs (identification) for the first user and a second user from the approved contact;
generating a security code for a first user pair, wherein the first user pair contains the first user and the second user;
creating a first A/V watermark for the first user pair;
validation of the first A/V watermark against a second A/V watermark during a communication session, wherein the second A/V watermark was created by the communication session; and
displaying an authentication status during the communication session.

9. The computer program product of claim 8, wherein creating unique IDs for the first user and the second user from the approved contact further comprises:
creating a first unique ID for the first user;
creating a second unique ID for the second user; and
storing the first and second unique ID.

10. The computer program product of claim 8, wherein generating the security code further comprises:
generating the security code, wherein the security code contains a first half of the security code and a second half of the security code;
assigning the first half to the first user and assigning the second half to the second user; and
transmitting the assigned first half to the first user and the assigned second half to the second user.

11. The computer program product of claim 8, wherein creating the A/V watermark further comprises:
verifying the security code of the first user pair; and
creating an A/V watermark for the first and the second user.

12. The computer program product of claim 8, wherein verifying the security code further comprises:
retrieving the first half of the security code from the first user;
retrieving the second half of the security code from the second user;
combining the first half and the second half to create a combined security code;
comparing the combined security code against the security code; and
determining whether the combined security code matches the security code based on the comparison.

13. The computer program product of claim 8, wherein validation of the A/V watermark further comprises:
detecting a presence of the second A/V watermark that is transmitted by the second user to the first user during a communication session;
retrieving the first A/V watermark from the server;
comparing the second A/V watermark against the first A/V watermark; and
generating the authentication status based on the comparison.

14. The computer program product of claim 8, wherein the communication session is selected from a group consisting of a text message, a voice call, and a video call.

15. A computer system for validating the authenticity of digital content between digital devices, the computer system comprising:
one or more computer processors;
one or more non-transitory computer readable storage media; and
program instructions stored on the one or more non-transitory computer readable storage media, the program instructions comprising the steps of:
registering a first user with a server;
registering and storing an approved contact associated with the first user;
creating unique IDs (identification) for the first user and a second user from the approved contact;
generating a security code for a first user pair, wherein the first user pair contains the first user and the second user;
creating a first A/V watermark for the first user pair;
validation of the first A/V watermark against a second A/V watermark during a communication session, wherein the second A/V watermark was created by the communication session; and
displaying an authentication status during the communication session.

16. The computer system of claim 15, wherein creating unique IDs for the first user and the second user from the approved contact further comprises:
creating a first unique ID for the first user;
creating a second unique ID for the second user; and
storing the first and second unique ID.

17. The computer system of claim 15, wherein generating the security code further comprises:
generating the security code, wherein the security code contains a first half of the security code and a second half of the security code;
assigning the first half to the first user and assigning the second half to the second user; and
transmitting the assigned first half to the first user and the assigned second half to the second user.

18. The computer system of claim 15, wherein creating the A/V watermark further comprises:
verifying the security code of the first user pair; and
creating an A/V watermark for the first and the second user.

19. The computer system of claim 15, wherein verifying the security code further comprises:
retrieving the first half of the security code from the first user;
retrieving the second half of the security code from the second user;
combining the first half and the second half to create a combined security code;
comparing the combined security code against the security code; and
determining whether the combined security code matches the security code based on the comparison.

20. The computer system of claim 15, wherein validation of the A/V watermark further comprises:
detecting a presence of the second A/V watermark that is transmitted by the second user to the first user during a communication session;
retrieving the first A/V watermark from the server,
comparing the second A/V watermark against the first A/V watermark; and
generating the authentication status based on the comparison.
